(19) United States
(12) Patent Application Publication
(10) Pub. No.: US 2026/0297703 A1
(43) Pub. Date: Oct. 1, 2026

(54) DYNAMIC CONTROL OF LITHIUM PRODUCTION FACILITY USING MODEL PREDICTIVE CONTROLLER

(71) Applicant: ExxonMobil Technology and Engineering Company, Spring, TX (US)

(72) Inventors: Sean A. MASON, Houston, TX (US); William C. HICKS, Spring, TX (US); Jason A. LOGAN, Spring, TX (US)

(21) Appl. No.: 19/558,750

(22) Filed: Mar. 6, 2026

Related U.S. Application Data
(60) Provisional application No. 63/777,171, filed on Mar. 25, 2025.

(51) Int. Cl. C22B 3/02; B01D 61/02; B01D 61/12; C02F 1/00; C02F 1/44; C22B 3/22; C22B 26/12

(52) U.S. Cl. CPC C22B 3/02; B01D 61/025; B01D 61/12; C02F 1/008; C02F 1/441; C22B 3/22; C22B 26/12; B01D 2313/701; B01D 2313/903; C02F 2209/006; C02F 2209/01; C02F 2209/02; C02F 2209/05; C02F 2209/06; C02F 2209/10; C02F 2209/20; C02F 2209/40; C02F 2209/42

(57) ABSTRACT

An apparatus and method for enabling lithium extraction. An exemplary embodiment provides an apparatus for lithium processing. The apparatus includes a number of sensors to measure a number of parameters of a brine stream. The apparatus further includes a model predictive controller to adjust a processing of the brine stream via a number of control parameters in response to detecting a change in at least one of the number of measured parameters of the brine stream.

### CROSS-REFERENCE TO RELATED APPLICATION

This application claims priority to and the benefit of U.S. Provisional Application No. 63/777,171, entitled “DYNAMIC CONTROL OF LITHIUM PRODUCTION FACILITY USING MODEL PREDICTIVE CONTROLLER,” having a filing date of Mar. 25, 2025, the disclosure of which is incorporated herein by reference in its entirety.

### FIELD

The present techniques generally relate to extraction of metals from brines. More specifically, the present techniques are directed towards methods and apparatuses for direct lithium extraction (DLE).

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Metals such as lithium are extracted from different sources for use in various products, including batteries. For example, lithium may take the form of lithium compounds, such as lithium carbonate or lithium hydroxide. Technical grade lithium carbonate is approximately 99% lithium carbonate by weight. The purity standard for battery-grade lithium carbonate may exceed 99.5%.

One available source of lithium is from brines containing lithium among other metals. Such brines may be obtained from various sources. A number of brine sources exist naturally. For example, brine sources include brine deposits like the Salar de Atacama in Chile, Silver Peak Nevada, Salar de Uyuni in Bolivia, the Salar de Hombre Muerte in Argentina, or the Smackover Formation in Arkansas, among other natural deposits.

One currently used method of obtaining metals such as lithium from brines involves the use of solar evaporation ponds. In solar evaporation ponds, evaporation is used to enrich the brine and thus increase the concentration of metals in the brine. Chemical treatments may then be used to purify the brine and reduce impurities. The purified brine may then be converted into a lithium compound via a conversion process. For example, the conversion process may involve the use of a crystallization process to produce the lithium compound. The crystallizers may require a feed brine input with lithium concentrations in excess of about 60,000 parts per million (ppm) and impurity concentration of less than 500 ppm. By contrast, the water chemistry from commercial brine sources may tend to have lithium concentrations on the order of 100-1,000 ppm and a total dissolved solid concentration exceeding 50,000 ppm. Solar evaporation may thus be used to increase lithium concentrations, with chemical treatments to reduce impurities.

However, the usage of solar evaporation ponds may be restricted to use in arid environments that tend to be at high altitudes and remote. Moreover, production time using solar evaporation ponds is long, potentially taking up to 18 months to reach adequate concentrations of lithium or other metals. In addition, solar evaporation has a low selectivity to lithium that requires higher quality brines while recovering less than 50% of lithium. Finally, solar evaporation methods have large land requirements as well as a need for fresh water in arid environments. An improved process of lithium production is desirable.

### SUMMARY

An exemplary embodiment provides an apparatus for lithium processing. The apparatus includes a number of sensors to measure a number of parameters of a brine stream. The apparatus includes a model predictive controller to adjust a processing of the brine stream via a number of control parameters in response to detecting a change in at least one of the number of measured parameters of the brine stream.

Another exemplary embodiment provides a method of operating a lithium plant. The method includes receiving, at a model predictive controller, sensor data from a sensor of a lithium process. The method includes adjusting, via the model predictive controller, a process in real time to a locally less optimal state using a number of control parameters to optimize an objective function.

These and other features and attributes of the disclosed embodiments of the present techniques and their advantageous applications and/or uses will be apparent from the detailed description that follows.

### BRIEF DESCRIPTION OF THE DRAWINGS

The advantages of the present techniques are better understood by referring to the following detailed description and the attached drawings, in which:

FIGS. 1A-1C are a schematic diagram depicting of an apparatus for the removal of lithium from a lithium-containing brine, according to embodiments herein;

FIGS. 2A and 2B are a schematic diagram depicting an example control schema for a lithium extraction system with one direct lithium extraction (DLE) unit, according to an embodiment;

FIGS. 3A and 3B are a schematic diagram depicting an example control schema for a lithium extraction system with two DLE units, according to an embodiment;

FIG. 4 is a schematic diagram depicting an example control loops in a pretreatment system of a lithium plant, according to an embodiment;

FIG. 5 is a schematic diagram depicting an example control loops in a concentration, refinement, and conversion (CRC) system of a lithium plant, according to an embodiment;

FIG. 6A is a process flow diagram of a method for processing lithium using an overall objective function, according to another embodiment;

FIG. 6B is a process flow diagram of a method for increasing overall lithium production in a lithium plant, according to another embodiment; and

FIG. 6C is a process flow diagram of a method for increasing divalent removal in a lithium process, according to another embodiment.

### DETAILED DESCRIPTION

As used herein, the following terms shall have the following meanings.

As used herein, “brine” or “brine solution” refers to any aqueous solution that contains a substantial amount of dissolved metals, such as alkali and/or alkaline earth metal salt(s) in water, wherein the concentration of salts can vary from trace amounts up to the point of saturation. Generally, brines suitable for the methods described herein are aqueous solutions that may include alkali or alkaline earth metal chlorides, bromides, sulfates, hydroxides, nitrates, and the like, as well as natural brines. In certain brines, other metals like lead, manganese, and zinc may be present. Exemplary elements present in the brines can include sodium, potassium, calcium, magnesium, lithium, strontium, barium, iron, boron, silica, manganese, chlorine, zinc, aluminum, antimony, chromium, cobalt, copper, lead, arsenic, mercury, molybdenum, nickel, silver, thallium, vanadium, and fluorine, although it is understood that other elements and compounds may also be present. Brines can be obtained from natural sources, such as Chilean brines or Salton Sea brines, geothermal brines, Smackover brines, sea water, mineral brines (e.g., lithium chloride or potassium chloride brines), alkali metal salt brines, and industrial brines, for example, industrial brines recovered from ore leaching, mineral dressing, and the like. Brines include continental brine deposits, geothermal brines, and waste or byproduct streams from industrial processes, synthetic brines, and other brines resulting from oil and gas production. In some embodiments, the brines are brines from which energy has already been extracted. For instance, brines used herein include brines from which a power plant has already extracted energy through methods such as flashing.

The term “deep subsurface brine” refers to a saline solution that has circulated through rocks deep in reservoirs such as those found in East Texas, North Dakota, and Arkansas in the United States, and in Alberta, Canada.

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present techniques.

The term “geothermal brine” refers to a saline solution that has circulated through the crustal rocks in areas of high heat flow and has become enriched in substances leached from those rocks. Geothermal brines, such as those found in the Salton Sea geothermal fields, can include many dissolved metal salts, including alkali, alkaline earth, and transition metal salts.

The term “concentrated” in reference to a brine (e.g., “concentrated brine” or “concentrated deep subsurface brine”) refers to brines that have reduced water content compared to the original brine. The reduced water content brine may be subsequently diluted post-concentration to prevent salt precipitation. In some embodiments, concentrated brines can result from various stages used during a DLE process.

The term “lithium salts” can include lithium nitrates, lithium sulfates, lithium bicarbonate, lithium halides (particularly chlorides and bromides), and acid salts. For example, the Salton Sea brines have lithium chlorides.

As used herein, “lithium selectivity” refers to the ability of a sorbent to preferentially extract lithium while rejecting impurities.

As used herein, “loading capacity” refers to the extracted lithium per unit of sorbent.

As used herein, a model predictive controller (MPC) refers to a process control system that uses a model to predict and optimize a system's future behavior. An MPC may be used to control a process while satisfying a set of constraints. An MPC also understands the time it takes for a change to propagate into the output, as these processes often have hold tanks or residence times. Therefore, an MPC tunes the magnitude of the response to the desired output and time. One example of an MPC is a dynamic matrix controller (DMC). A DMC utilizes a dynamic matrix to predict the future behavior of a system based on its step response, allowing it to calculate optimal control actions to achieve a desired setpoint, making it particularly useful for complex multivariable systems in industries like chemical processing and refining.

As used herein, precipitates of iron oxides include iron oxides, iron hydroxides, iron oxide-hydroxides and iron oxyhydroxides.

The term “Smackover brine” refers to a type of mineral-rich water that is found in the Smackover Formation, a geological layer that formed during the Jurassic period and spans across several states in the southern United States. Smackover brines are considered a resource for lithium and bromine in particular. Smackover brines may be extracted from the Smackover Formation by pumping them from wells that reach the limestone aquifer. The brines are then processed to separate the lithium and bromine from the water and other minerals.

The term “treated” in reference to a brine (e.g., “treated brine”) refers to brines that have been processed such that the concentration of at least one metal or elemental component has been reduced in the brine. For instance, a brine in which the concentration of silica and iron has been reduced is a treated brine, also referred to as reduced silica and iron brine.

The term “lithium salts” can include lithium nitrates, lithium sulfates, lithium bicarbonate, lithium halides (particularly chlorides and bromides), and acid salts. For example, the Salton Sea brines have lithium chlorides.

As used herein, precipitates of iron oxides include iron oxides, iron hydroxides, iron oxide-hydroxides and iron oxyhydroxides.

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

Historically, lithium extraction has taken place in salar ponds, where a time-based solar evaporation occurs. With a new technology, direct lithium extraction (DLE) is leveraged to allow for continuous flow operation to process lithium containing brines. Direct lithium extraction (DLE) is a selective lithium extraction process that enables selective recovery of lithium from a complex mineral mix of brine. DLE has lower recovery times in the order of hours or days rather than months. Moreover, DLE enables greater than 90% recovery of lithium from brines. In addition, DLE utilizes less land area and can be conveniently deployed anywhere.

DLE can be integrated with other technologies for production of lithium product. For example, such technologies may include a precipitator, reverse osmosis, filtration, multi-effect evaporator, and crystallizer, or any combination thereof. Sorption-based techniques are also used for recovery of lithium. For example, a lithium-aluminum-layered double hydroxide chloride sorbent (LAH or AlOH) is sometimes used. DLE today is typically used on salt lake assets. DLE salt lake brine producers make use of evaporation ponds to assist with the pre-treatment, impurity removal, and dewatering, and do not re-inject the water back into the reservoir. However, the water chemistries may have much less impurities than deep subsurface brines because such DLE producers either produce the lithium from the tailings of other brine operations or they target resources for their low impurity concentrations. For example, some producers process their lithium from the brine tailings of their potash operations, which significantly cleans up the water. Some other DLE operations have specifically targeted salt lakes with water chemistries that are more suitable for DLE.

Thus, a different DLE flow may be used on deep subsurface brines as compared to DLE operations with ponds. In particular, the need for impurity removal and dewatering steps may be greater and thus addressed solely with industrial facilities. The key cost drivers may thus be determined by the cost associated with each processing step (i.e. pre-treatment, the DLE step, impurities removal, and dewatering to enhance lithium concentration), and can be categorized as robustness to water chemistry, lithium selectivity, and loading capacity. The three of these processing steps—pre-treatment, impurity removal, and dewatering—are all tied directly to the DLE process, and therefore, the costs are not necessarily independent of one another, as described in greater detail below. Generally, with respect to robustness to water chemistry, the pre-treatment steps prior to DLE must process the largest volume up front, such as chemical treatment or filtration, to remove impurities that cause unsafe operations, scaling issues, or deteriorate sorbent performance.

DLE technology robustness against a wide range of water chemistries can minimize the need for pre-treatment and its cost. With respect to lithium selectivity and loading capacity, the lithium concentrated stream after DLE may still require further refinement to produce a battery grade product, thus necessitating additional post-treatment. The amount of impurities remaining after DLE is determined by the lithium selectivity, while the lithium concentration post DLE is determined by the loading capacity of the sorbent. Post DLE processes are designed to remove residual impurities, boost lithium concentration, and convert to high purity lithium carbonate or lithium hydroxide, and therefore, post-treatment processes will endure more cost for larger quantities of impurities and lower lithium concentrations post-DLE. For example, post DLE processes may include chemical treatments, filtration, dewatering, and crystallization.

While these cost drivers are described independently, they can be highly correlated. For example, lithium selectivity, loading capacity, and robustness may all be tied to the same or correlated physical mechanisms. Another additional complexity is that the mechanisms that enable the use of a particular material in the DLE step to selectively extract lithium rely on thermodynamically favored conditions, and different source brines will be unique in their make-up, and even small differences in water chemistry may alter the thermodynamics in a manner that also influences lithium selectivity and loading capacity. Therefore, these key cost drivers cannot be considered independent of one another or in the absence of the water chemistry under consideration. Therefore, DLE may work best if engineered for a specific lithium deposit. Unlike pond-assisted DLE, the spent brine may also need to be re-injected or cleaned prior to surface discharge.

DLE processes can have up to 98-99.9%+ rejection of ions, such as calcium or magnesium, among other ions. In some examples, a nanofilter can be used in a lithium plant to further remove calcium or magnesium. For example, multiple nanofilters can be used in series, with a more concentrated stream going to the N, N+1, etc., nanofilter. As the train of filters increases, the ionic concentration of the stream increases. However, from the first to the last nanofilter, the concentration of ions may increase by a factor of 2-10 as permeate water is continually removed from the stream. Therefore, to maintain a high operating flux necessary to prevent scaling and optimize performance, the pump pressure may sometimes be increased to overcome the increased osmotic pressure.

In addition, nanofiltration also relies on an optimal flux rate to ensure that there is optimal lithium passage. If the flux is too high, there will not be good separation of ions, but if the flux is too low, scaling can occur. As the osmotic pressure of the stream increases, without sufficient pump pressure, there may reduced ionic separation.

Moreover, although some methods may use electrical conductivity meters for lithium processes and some localized automation of control, the integration between DLE and concentration, refinement, and conversion (CRC) is sparse. Moreover, because the end-product of lithium extraction is a very high purity (99.5%+ by weight) lithium carbonate and very low ppm levels of boron, calcium, sodium, and other impurities, precise control schemes are needed to react to an ever-changing brine composition from the ground. For example, as reinjection into the ground occurs, the composition of the feed may change, and by proxy, the required processing capabilities. Therefore, a system that integrates DLE with CRC in a real time adjustable manner that optimizes lithium extraction is desired.

Accordingly, embodiments described herein enable more efficient extraction of lithium and other metals from deep subsurface brines, among other sources of brine. In various embodiments, a process is described with improved overall combination of pre-treatment, DLE, and CRC streams for improved extraction of lithium. The embodiments include the use of a model predictive controller (MPC) to adaptively control a lithium facility in real time. For example, the techniques may include deployment of a dynamic matrix controller and distributed control systems to automate process steps and parameters in a lithium extraction facility. A dynamic matrix controller is an automated process control system that has a set of inputs and manipulated variables to achieve a desired output. A dynamic matrix controller is typically tuned on a commercial operation to determine the impact each manipulated variable has on a desired output. In various embodiments, such an integrated control system is used to coordinate various dynamic aspects of pretreatment, direct lithium extraction, and concentration, refinement, and conversion (CRC) of a lithium brine into a lithium carbonate or lithium hydroxide product. For example, a pretreatment stage may include precipitation of impurities, three phase separation, hydrogen sulfide (H₂S) strippers, cyclone separators, micro/ultra-filtering, or de-oiling. Control parameters for the pretreatment stage may include liquid, gas, organic levels or flows in the three phase separator, steam rate or temperature in the H₂S stripper, or flux through a filter. A DLE stage may include the use of stripping, displacement, adsorption, and temperature control of the lithium column. Control parameters of the DLE stage may include column configuration (controlled, e.g., via a valve array), column step time, flow rates of each step, number of columns in series or parallel, temperature of DLE operation, pressure, total recycle rate, and total recycle water composition. A CRC stage may include control of reagent addition for precipitation, control of flux on nanofiltration, control of flux on reverse osmosis, control of thermal evaporation rate, control of sodium carbonate addition, control of ion exchange columns. Control parameters of the CRC stage may thus include various CRC control parameters, such as NF temperature, pressure, feed flow, flux, recovery percent, pH and cleaning frequency. These control parameters may also include IX parameters, such as space velocity, pH, temperature, feed flow, regen frequency, inlet divalent and outlet divalent concentration. In various embodiments, similar control parameters may be used for a boron IX. In various embodiments, the CRC control parameters may also include carbonation temperature, pressure, steam jacket rate, agitator speed, carbonate addition, carbonate content, etc.

In various embodiments, the methods of automatically controlling the various stages may include the use of various sensors, including sensors measuring pH, electrical conductivity, turbidity, density, and gas chromatography, temperature, pressures, flow rates, single and multi ionic concentration measurements, nuclear magnetic resonance (NMR), x-ray fluorescence (XRF), among others. These different measurement methods can be used to enable a dynamic process control that is new to a continuous flow operation and not seen in historical salar ponds. Such real-time adjustment may typically not be useful in salar ponds due to the long processing time and the lag in time between steps, such that there may be less benefit that in a flow system. Full integration with a cost matrix would allow for an MPC to prioritize steps based on overall economics as an integrated system. For example, a nanofilter could have a process vector that wants to maximize divalent removal and an ion exchange bed could have a process vector to maximize flow rate to allow the bypass of beds. An MPC can be used to weigh the cost of nanofiltration versus ion exchange bed to allow for optimal ion passage out of nanofiltration into ion exchange to either bypass a bed entirely, or allow more ions out of nanofiltration if it is known an additional ion exchange bed is needed. In some embodiments, an instrument could be placed on the outlet of an evaporator to read impurities such as final organics and link back to the three-phase separator or de-oiling cyclones to decrease flow rate or increase separation to remove further amounts of organics. The higher the carbonate removal, the higher the divalent ion removal, but there is also an increase in lithium losses. An MPC enables the user to optimize an objective function that not only accounts for the reagent amount added, but reagent concentration, temperature, pressure, etc. In some embodiments, a first process may be run sub-optimally to optimize a second process or the entire plant. For example, reagent addition often changes the pH of the stream, and the concentration of the reagents increase the overall volume of the stream after processing. An integration step with nanofiltration may require lower pH for best divalent removal, allowing for suboptimal reagent addition to maximize lithium recovery, which is not the goal of softening. This may in turn optimize an objective function.

The embodiments thus enable the process steps to react to changes in the brine in real time to minimize overall lithium loss. For example, if the calcium concentration suddenly rises, more carbonate or sulfate may be added to prevent too much impurity slip that may cause the downstream system to not be able to process as much osmotic pressure/impurities. As another example, if the calcium were to suddenly drop, over carbonation/sulfation of the system may result in too high of a lithium drop out, hurting the economics of the process. The embodiments herein may enable less carbonate or sulfate to be added to prevent such over carbonation/sulfation of the system. Alternatively, more acid could be added to the nanofiltration step to increase the divalent removal, or the ion exchange beds could cycle faster to increase divalent removal capacity.

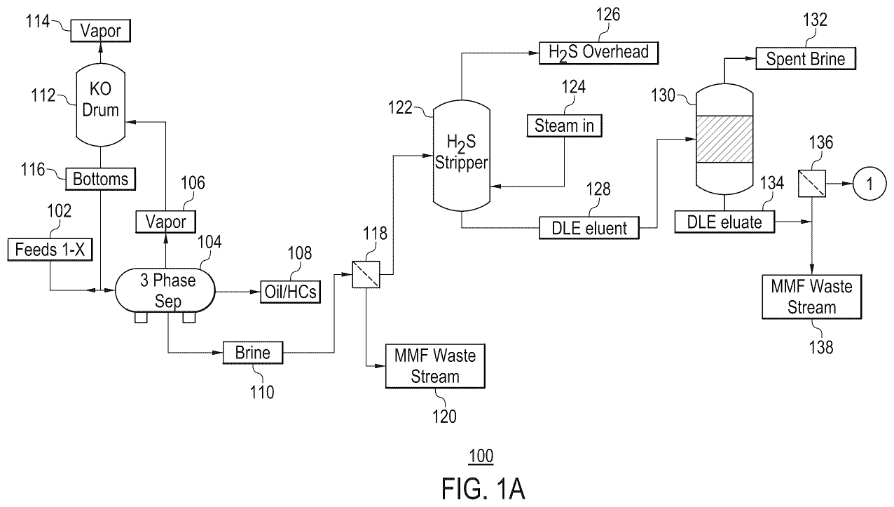

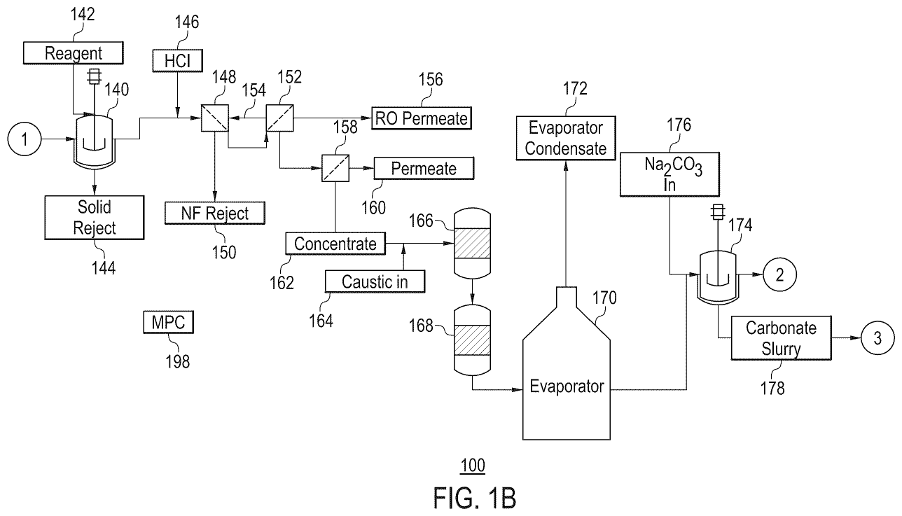

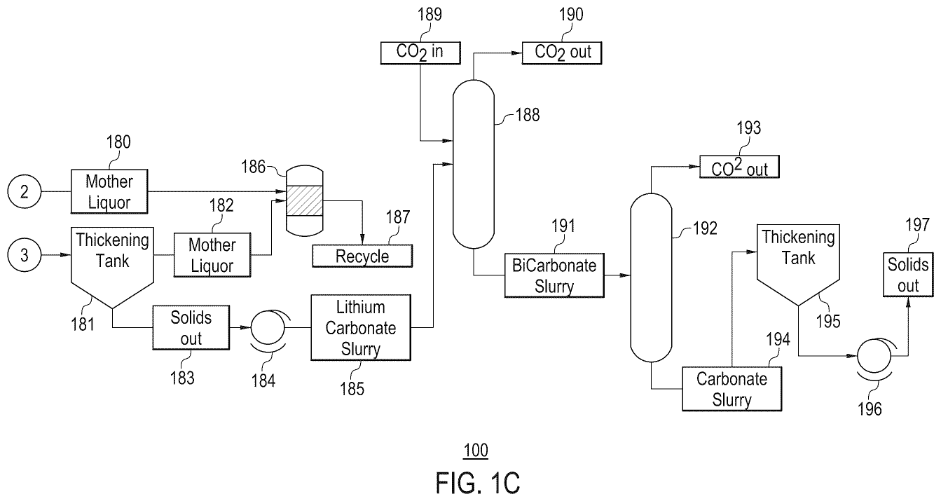

Referring now to FIG. 1A, an apparatus 100 for the removal of lithium from a lithium containing brine is provided. A brine containing lithium and other metals is provided via a well in any number of feeds 102. For example, the brine received from the well in feeds 102 may be a deep subsurface brine from an underground reservoir.

The apparatus 100 includes a three-phase separator 104 that receives input feed 102 and generates vapor 106, oil/hydrocarbons 108, and brine 110. The apparatus 100 also includes a knockout (KO) drum 112 fluidically coupled to the three-phase separator 104. The KO drum 112 receives vapor 106 and produces vapor 114 and bottoms 116.

The apparatus 100 also further includes a filter 118 fluidically coupled to the KO drum 112. For example, the filter may be a multi-media filter (MMF). The filter 118 receives brine 110 and produces a filtered stream and an MMF waste stream 120. The filtered stream is sent to a hydrogen sulfide (H₂S) stripper 122 that is fluidically coupled to the filter 118.

The H₂S stripper 122 receives input filtered stream from filter 118 and stream 124, and generates hydrogen sulfide overhead 126 and direct lithium extraction (DLE) eluent 128. The hydrogen sulfide overhead 126 is discarded.

The apparatus 100 includes a direct lithium extraction (DLE) unit 130 fluidically coupled to the H₂S stripper 122. The DLE unit 130 receives input DLE eluent 128 and outputs spent brine 132 and DLE eluate 134. For example, the spent brine 132 may be lithium depleted brine that is deposited back into a reservoir. The DLE unit 130 can increase both the ratio of lithium to impurities and the lithium concentration and, regardless of the technique and materials used, this is accomplished by swapping lithium out of the source brine into a fresh water stream (not shown). In various embodiments, the fresh water stream may be either make up water or recycled RO/evaporation overheads. In various examples, depending on the techniques applied, additional reagents may also be added to the fresh water stream. For example, such reagents may include sodium sulfate (Na₂SO₄), sodium hydroxide (NaOH), sodium carbonate (Na₂CO₃), hydrochloric acid (HCl), or sulfuric acid (H₂SO₄), among other reagents. Each of the steps before and after DLE unit 130 are thus tied to the DLE unit 130 and the materials used to promote this swap. If impurities in the water might harm the DLE unit 130, then these impurities are first removed and this is done in the pre-treatment process prior to the DLE unit 130.

In various examples, the spent brine 132 generated by the DLE unit 130 is discarded. In some examples, the spent brine 132 is collected and disposed either onto the surface or re-injected into a subsurface reservoir. For surface disposal, regulatory approval may be required, and depending on location, large quantities of impurities may need to be removed. For reinjection, retention of impurities are required to ensure compatibility with the original subsurface brine. In some examples, the spent brine 132 may be additionally treated before being injected into the reservoir. For example, if too many components are depleted from or added to the spent brine 132 relating to the pre-treatment and DLE processing step, then the spent brine 132 may need to be rebalanced to be compatible with the subsurface brine. Otherwise, an incompatible brine may present a risk of excessive scaling and improper pressure maintenance of the reservoir or well.

In various embodiments, the DLE eluate 134 may include various impurities. For example, there may be some amount of impurities that remain with the lithium after processing by the DLE unit 130 because no material and technique that can perfectly select for lithium may exist. In various examples, such remaining impurities may include calcium (Ca), boron (B), magnesium (Mg), sodium (Na), strontium (Sr), silicon (Si), zinc (Zn), iron (Fe), potassium (K), argon (Ar), lead (Pb), nickel (Ni), or copper (Cu), among other remaining impurities. Therefore, a post-DLE impurity removal process may be used to remove any such remaining impurities.

The apparatus 100 therefore includes a second filter 136 fluidically coupled to the DLE unit 130. In various embodiments, the filter 136 is a multi-media filter (MMF) and ultrafiltration filter (UF) or a combination thereof. The second filter 136 receives DLE eluate 134 and outputs a MMF waste stream 138 and a filtered stream that is sent to a fluidically coupled softening unit 140 as indicated between figures using circle 1.

Referring now to FIG. 1B, the softening unit 140 may include a softening tank that receives a reagent 142 and mixes the reagent 142 with the filtered stream from the filter 136 to produce solid reject 144 and a softened stream that is treated with hydrochloric acid (HCl) 146 before being received at a nanofilter (NF) 148.

The nanofilter 148 receives the treated, softened stream and produces a nanofilter reject 150 and a filtered stream that is sent to fluidically coupled reverse osmosis (RO) unit 152. In various embodiments, the nanofilter reject 150 is discarded.

The RO unit 152 receives a filtered stream and produces a recycled stream 154, RO permeate 156, and RO concentrate that is sent to a fluidically coupled special RO unit 158. In various embodiments, the recycled stream 154 includes various ionic components, including any combination of Cl, Br, CO₃, SO₄, F, Li, Na, K, Ca, Ba, Mg, Mn, Fe, Si, Sr, B, and/or Al. In various embodiments, the recycled stream 154 can be used in a DLE stripper, as a DLE feed, an RO feed, an NF feed, an IX feed, or any combination thereof.

The special RO unit 158 receives the RO concentrate from the RO unit 152 and produces permeate 160 and concentrate 162. In various embodiments, the special RO unit 158 may take multiple forms, such as low salt rejection (LSRRO), osmotically assisted (OARO), brine concentration (BCM), sea water RO (SWRO), brackish water RO (BWRO), ultra-high pressure RO (UHPRO), or any combination thereof.

In various embodiments, the concentrate 162 is combined with an input caustic 164 before being received at a divalent ion exchange (IX) 166. For example, the caustic 164 may be sodium hydroxide (NaOH), sodium carbonate (Na₂CO₃), or any other suitable caustic.

The divalent IX 166 outputs a filtered stream to a boron IX 168 with which the divalent IX 166 is fluidically coupled. The boron IX 168 filters out boron from the filtered stream and outputs a boron reduced stream to an evaporator 170 that is also fluidically coupled to the boron IX 168. In some embodiments, the boron IX 168 may alternatively be coupled before divalent IX 166. In these embodiments, the boron IX 168 may filter out boron from the concentrate combined with caustic 164 and output the filtered stream to the divalent IX 166. The divalent IX 166 then further filters the stream and outputs a filtered stream to the evaporator 170.

The evaporator 170 receives the boron reduced stream and produces evaporator condensate 172 and a concentrated stream. For example, the evaporator condensate 172 may include water and other condensates.

The apparatus 100 includes a carbonation reactor 174 fluidically coupled to the evaporator 170. The carbonation reactor 174 receives the concentrated stream and an input sodium carbonate 176 and outputs a carbonate slurry 178 and a mother liquor 180.

Referring now to FIG. 1C, the apparatus 100 includes a thickening tank 181 fluidically coupled to the carbonation reactor 174. The thickening tank 181 receives carbonate slurry 178 as indicated between figures using circle 3, and produces mother liquor 182 and solids 183. The mother liquor 182 is the residual liquid that remains after the solids 183 have been crystalized. For example, the mother liquor 182 may include any combination of Li, Na, K, Ca, B, Cl, CO₃, SO₄, and/or Br. In various examples, the solids 183 include Li₂CO₃, NaCl, KCl, LiCl, Na₂CO₃, CaCO₃, BaCO₃, K₂CO₃, and/or CaCl₂.

The apparatus 100 also includes a centrifuge 184 fluidically coupled to the thickening tank 181. In various embodiments, the centrifuge 184 receives solids 183 and produces a lithium carbonate slurry 185 and an additional mother liquor that is sent to be mixed with the mother liquor 182 and processed in a mother liquor (ML) recovery unit 186.

The ML recovery unit 186 receives a mix of mother liquor 180 from the carbonation reactor 174 as indicated between figures by circle 2, and mother liquor 182, and produces a recycle stream 187. in various examples, the recycle stream 187 may include characteristics that may impact decision making of the MPC, such as lithium content, sodium content, boron content, lithium to sodium ratio, lithium to boron ratio. In various embodiments, the recycle stream 187 may be sent to the DLE 130, a secondary DLE, filtration unit 136, and/or pretreatment 204.

The apparatus 100 also includes a bicarbonation vessel 188 fluidically coupled to the centrifuge 184. The bicarbonation vessel 188 receives input lithium carbonate slurry 185 and carbon dioxide 189 and produces output carbon dioxide 190 and bicarbonate slurry 191.

The apparatus 100 further includes a re-carbonation vessel 192 that receives the bicarbonate slurry 191 and produces carbon dioxide 193 and a carbonate slurry 194. The apparatus 100 includes a second thickening tank 195 that is fluidically coupled to the re-carbonation vessel 192. The second thickening tank 195 receives the carbonate slurry 194 and outputs thickened carbonate slurry. The apparatus 100 also further includes a second centrifuge 196 that is fluidically coupled to the second thickening tank 195. The second centrifuge 196 receives the thickened carbonate slurry from the second thickening tank 195 and outputs solids 197. For example, the solids 197 may be a lithium product, such as lithium carbonate (Li₂CO₃).

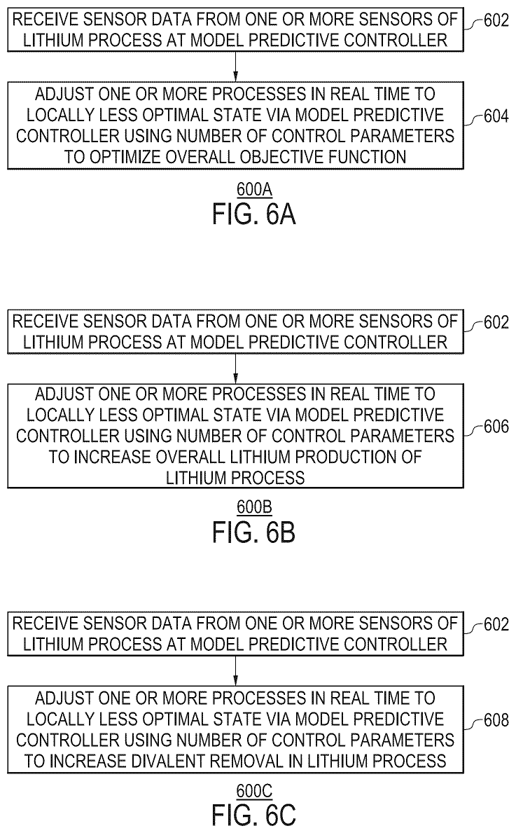

As shown in FIG. 1A, a lithium enrichment and purification process is shown that feeds a pretreated brine into the DLE unit 130. A following concentration, refinement, and conversion (CRC) stage is then used to produce a final product composed of solids 197. In various embodiments, the apparatus 100 includes a model predictive controller (MPC) 198 to control various aspects of the pretreatment or concentration, refinement, and conversion. For example, the model predictive controller 198 may be a dynamic matrix controller that receives various inputs and determines dynamic modifications to the processes in order to optimize to a goal. For example, the goal may be an overall objective function as described in method 600A of FIG. 6A. In some embodiments, the goal may be an increase in the overall lithium production, as described in method 600B of FIG. 6B. In some embodiments, the goal may be increased divalent removal as described in method 600C of FIG. 6C.

In various embodiments, the methods of automatically controlling the various stages may include the use of various sensors, including sensors measuring pH, electrical conductivity, turbidity, density, and gas chromatography, among others. The sensors may be used to measure various specific parameters, including flow rate, temperature, pressure, density, pH, electrical conductivity, Total Dissolved Solids (TDS), Total Suspended Solids (TSS), lithium content, sodium content, other cationic contents, total organic content (TOC), NMR to measure ionic content, and calculated values based on these parameters. For example, flux can be calculated from the flow rate parameter.

In various embodiments, any number of interactions may be monitored and controlled by the MPC 198, including interactions between the DLE, CRC, and pretreatment components. The MPC 198 can monitor and control many streams, for example, but not limited to, surface brine pre-air sparging, air sparged brine, post-precipitation brine, brine after an adsorption step such as direct lithium extraction, brine going into a nanofiltration system, brine going into a reverse osmosis system, permeate from nanofiltration or reverse osmosis streams, retentate from nanofiltration or reverse osmosis streams, evaporator feed streams, lithium carbonate reactor feed streams, or crystallizer feed for a lithium facility.

As one example, if the pH of a precipitation step is detected as exceeding a threshold, this may be indicative of over-addition of a reagent, and may impact the amount of ion exchange flow needed. In this example, the MPC 198 may allow for bypass of a bed.

As another example, if the electrical conductivity of a stream out of nanofiltration is detected as exceeding a threshold, that may indicate a higher concentration of ions in the stream. In this example, the MPC 198 may accordingly force a nanofiltration system to operate at either lower fluxes or with an increased number passes through the filtration system.

As yet another example, if the turbidity measurement of the stream is detected as exceeding a threshold, this may indicate that there are more suspended solids out of lithium carbonation that did not dropout, and it could indicate less solids dropout than desirable. Similarly, if the density of a stream increases, this may indicate that there is higher solids or salinity of a stream. In this example, the MPC 198 may cause the equipment downstream to be run at lower fluxes or space velocities for improved separation while optimizing the overall objective function. In various embodiments, the MPC 198 may alternatively predict a certain DLE eluant and calculate a flow path for a nanofilter, ion exchange, and/or reverse osmosis that optimizes an objective function factoring in the time lag of the process. For example, the MPC 198 may predict a worse slug of fluid and begin the movement of ion exchange columns a couple hours in advance to ensure that an objective function is optimized.

As one example, using gas chromatography, multiple pretreatment streams may contain hydrogen sulfide in them at ppm to wt % levels such that can a GC-analyzer may be used to determine total composition. In this example, if the composition is detected as exceeding a threshold, then the steam rate or 3-phase separator operation can be changed. Alternatively, as another example, if the composition is lower than needed, then the steam rate may be decreased.

The MPC 198 may thus adjust any number of components in the apparatus 100 in response to various types of disturbances. As one example, the DLE unit 130 may have either a poor valve or a high impurity feed spike that results in higher Ca and Na in the DLE eluate 134 fed into the subsequent CRC system than typical. In various embodiments, responsive to detecting the higher Ca and Na, the MPC 198 can increase RO strip water rate into DLE to dilute an intermediate tank feeding the NF unit (pending the tank existence). However, increasing the RO strip water rate may produce a more dilute product, less Li flow per time, and may also likely require higher RO skid power to remove excess water. In some embodiments, responsive to detecting the higher Ca and Na, the MPC 198 can alternatively increase acid flow rate injection into the NF system to improve divalent removal. However, increasing acid flow rate may increase acid cost as well as decrease membrane lifetime from higher acid environment. In some embodiments, responsive to detecting the higher Ca and Na, the MPC 198 can greatly decrease the flux of the NF unit to reduce Ca into the permeate, which would ultimately decrease flow out of the NF unit. However, decreasing the flow out of the NF unit also reduces lithium flow. In some embodiments, responsive to detecting the higher Ca and Na, the MPC 198 can alternatively run through an ion exchange and regenerate the columns faster. However, running through the ion exchange may increase overall sodium content into the product and increase reagent costs to regenerate. Running through the ion exchange may also decrease the lifetime of the resin. In some embodiments, responsive to detecting the higher Ca and Na, the MPC 198 can increase sodium carbonate or hydroxide rate into the softening unit 140 to remove more Ca. However, increasing the sodium carbonate or hydroxide rate may similarly increase reagent costs and Na impurity into the product. Increasing the sodium carbonate or hydroxide rate may also greatly increase the solid reject 144.

By focusing on an overall goal of the apparatus 100, such as lithium production or divalent removal represented by an overall objective function, the MPC 198 enables improved overall performance with respect to these goals. For example, whereas a simple controller may directly adjust acid downstream of the DLE to immediately fix in the NF, the MPC 198 may instead take in multiple options and even do small amounts of multiple different adjustments. For example, instead of adjusting a single aspect of a single component, the MPC 198 may cause modifications in acid, some flow adjustment, and some strip water adjustment. In some embodiments, the MPC 198 may be tuned based on commercial data for all of the options known to be available for the apparatus 100 and optimize the apparatus 100 not just on the corrective action, but with knowledge of how long each change would take to affect the product.

It is to be understood that the block diagrams of FIGS. 1A-1C are not intended to indicate that the apparatus 100 is to include all of the components shown in FIGS. 1A-1C. Rather, the apparatus 100 can include fewer or additional components not illustrated in FIGS. 1A-1C (e.g., additional streams, filters, etc.). For example, although a softening unit 140 and nanofilter 148 are both included, in various embodiments, one or both of the softening unit 140 and nanofilter 148 may be excluded. In some embodiments, the bicarbonation vessel 188 may also be excluded. For example, the bicarbonation vessel 188 may be unnecessary depending on the purity of the lithium carbonate. Moreover, various auxiliary equipment is not depicted in FIGS. 1A-1C. For example, the auxiliary equipment may include pumps, compressors, valves, exchangers, and intermediate tankage. In some embodiments, the apparatus 100 may include a dewatering process that receives purified lithium solution from the impurity removal process. For example, after processing at the DLE unit 130, the lithium concentration may still be less than an example target concentration of 30,000 ppm. In various embodiments, the target concentration for lithium is within the range of 15,000 to 45,000 mg/L Li. Therefore, a dewatering process may be applied to remove the water from the purified lithium solution. In some embodiments, once all the above enrichment and purification steps are completed, the lithium enriched brine is fed to a conversion process to produce a saleable battery grade lithium product 197. For example, the conversion process may include the use of a crystallizer that can generate lithium products such as lithium carbonate, lithium hydroxide monohydrate, or lithium phosphate, among other lithium products. In various embodiments, there thus may be fresh water, chemical, electrical, and sorbent manufacturing requirements to operate a DLE facility using the apparatus 100. In some embodiments, if the apparatus 100 is constructed in a remote location, then delivery of chemicals or sorbents may be unreliable and/or cost of transport of any such chemicals or sorbents may be prohibitive. Therefore, in some embodiments, chemicals and sorbents may also be produced on-site.

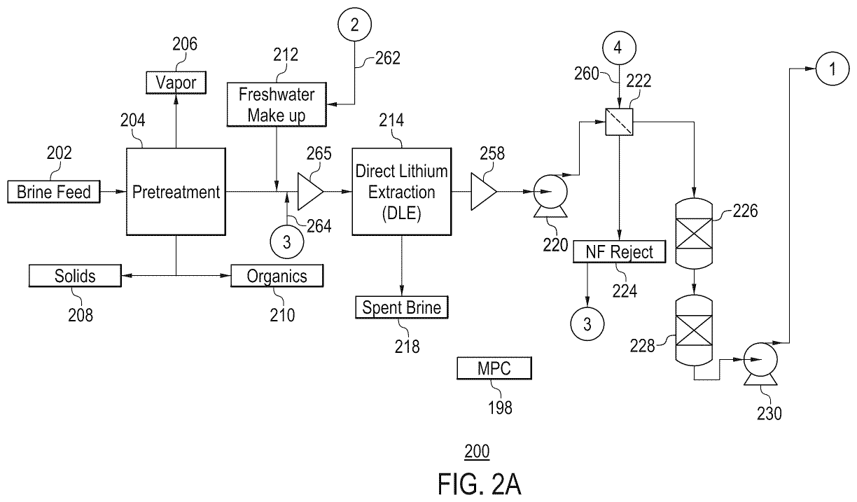

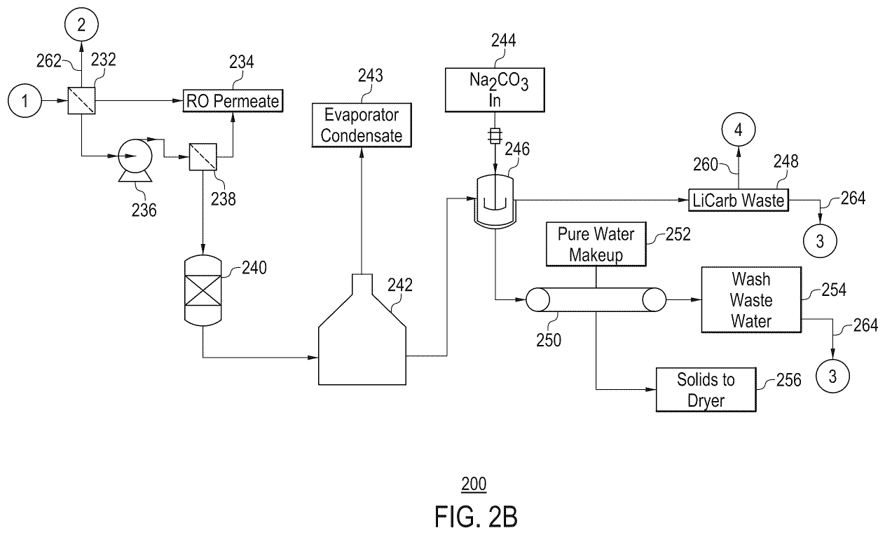

FIG. 2A is an illustration of an apparatus 200 for the extraction of lithium from a brine stream according to an embodiment. FIG. 2A shows a brine feed 202 being received at a pre-treatment unit 204. For example, the brine feed 202 may be a stream of brine from a well. In some examples, the brine feed 202 may have been pretreated using any suitable techniques, such as those described in FIG. 1. In various embodiments, the pretreatment unit 204 includes any of the elements of FIG. 1, such as a three-phase separator, a knockout drum, filter, hydrogen sulfide stripper, etc. The pretreatment unit 204 produces vapor 206, as well as solids 208 and organics 210, in addition to a pretreated stream that is mixed with freshwater makeup 212 before being sent to a direct lithium extraction (DLE) unit 214. For example, the solids 208 may include impurities that precipitate out due to the fluid being at supersaturated levels. For example, the organics 210 may include impurities that precipitate out due to the fluid being at supersaturated levels or an organic liquid phase.

The DLE unit 214 is shown receiving a pretreated brine stream from the pretreatment unit 204. The pretreated brine from the pretreatment unit 204 is then processed via the DLE unit 214 to generate spent brine 218 and a lithium-rich brine that is sent to a compressor 220. In various examples, the output stream of brine from the DLE unit 214 may be a concentrated lithium stream.

The apparatus 200 further includes various units generally forming a concentration, refinement, and conversion (CRC) system that is fluidically coupled to the DLE unit 214. For example, the apparatus 200 includes the compressor 220 fluidically coupled to the DLE unit 214. The compressor 220 pumps the lithium rich stream into a fluidically coupled nanofilter 222 at an increased pressure.

The nanofilter 222 generates a nanofilter reject stream 224 and a filtered stream that is sent to a fluidically coupled divalent ion exchange 226. The nanofilter 222 may be the first processing performed on the output stream from DLE unit 214. In various embodiments, the pretreated stream from the DLE unit 214 may be processed through any number of nanofilters to remove any variety of ions. For example, the nanofilter reject stream 224 may include calcium, magnesium, or any other ions present in the stream that may need to be removed. For example, additional anions to be removed include fluoride, bromide, chloride, sulfate, carbonate, and hydroxide, among others. In various examples, each of the nanofilters may include nano-sized holes through which the brine is passed at a certain flux rate and a certain pH, both of which may depend on the composition of the brine stream. For example, a stream having high amounts of boron may be processed with a different pH than a stream having low amounts of boron. Similarly, a stream with high amounts of impurities may be processed at a higher flux in order prevent scaling. However, there may be a tradeoff between how much lithium is recovered by the apparatus 200 and how much ions are rejected by the nanofilter 222. Therefore, the flux rate may also be kept lower in order to enable more lithium to be efficiently extracted.

The divalent ion exchange 226 interchanges of one species of ion present in an insoluble solid with another of like charge present in a solution surrounding the solid. In various embodiments, the insoluble solid is a resin containing a particular ion on its surface. In one embodiment, the resin has sodium (Na+) ions along its surface. The divalent ion exchange 226 thus removes divalents and replaces them with sodium ions. The divalent ion exchange 226 outputs a filtered stream into the boron ion exchange 228, which is fluidically coupled to the divalent ion exchange 226.

The boron ion exchange 228 similarly interchanges of one species of ion present in an insoluble solid with another of like charge present in a solution surrounding the solid. In various embodiments, the insoluble solid in the boron ion exchange 228 is a boron selective ion exchange resin. In various embodiments, the resin-based bed hits saturation and taken offline to regenerate the resin. Thus, in various embodiments, multiple ion exchange beds are used to allow for continuous operation of either the divalent ion exchange 226 or the boron ion exchange 228.

The apparatus 200 includes a second compressor 230 fluidically coupled to the boron ion exchange 228 and a medium pressure reverse osmosis (RO) unit 232, as indicated by circle 1. For example, the medium pressure RO unit 232 may be coupled to the second compressor 230 in order to pump the input stream pressure to within the range of 200-1,800 pounds per square inch (psi) or 1,380-12,410 kilopascals (kPa). The second compressor 230 may compress the stream to increase the pressure of the stream as the stream is input into the medium pressure RO unit 232.

Referring to FIG. 2B, the medium pressure RO unit 232 outputs an RO permeate 234. For example, the RO permeate 234 may be water among other fluids.

The apparatus 200 includes a third compressor 236 fluidically coupled to the medium pressure RO unit 232 and a high pressure RO unit 238. In various embodiments, the high pressure RO unit 238 may require the compressor to raise the input stream pressure to a higher pressure within the range of 200-1,800 psi, or 1,380-12,410 kPa. The apparatus 200 also includes a polishing ion exchange (IX) unit 240 fluidically coupled to the high pressure RO unit 238. For example, the polishing IX unit 240 can remove the very last amounts of impurities that may be left in the stream received from the high pressure RO unit 238. In some examples, if the main IX column including the divalent ion exchange 226 and boron ion exchange 228 has a maldistribution or somehow fails out, the polishing IX unit 240 can ensure that no impurities make it to the end of the process.

The apparatus 200 includes an evaporator 242 fluidically coupled to the polishing IX unit 240. For example, the evaporator 242 may be a boiler. The evaporator 242 generates an evaporator condensate 243 and a concentrated stream.

The apparatus 200 further includes a carbonation reactor 246 fluidically coupled to the evaporator 242. The carbonation reactor 246 receives the concentrated stream from the evaporator 242 and mixes the concentrated stream with input sodium carbonate 244. The carbonation reaction produces lithium carbonation waste 248 and a carbonate slurry.

The apparatus 200 includes a washer unit 250 fluidically coupled to the carbonation reactor 246. The washer unit 250 receives a stream of lithium carbonate slurry and pure water makeup 252, and outputs wash waste water 254 and solids 256. In some embodiments, the pure water makeup 252 is deionized (DI) water. In some embodiments, the washer unit 250 may take the form of a horizontal belt filter with a conveyor belt that moves lithium carbonate crystals in a filter through a series of hoses that wash the lithium carbonate with wash water. The wash water extracts sodium and lithium chloride that dissolves in the wash water and passes through the filter, leavening purified lithium carbonate crystals behind. In this manner, any number of water washes may be performed in a sequential manner resulting in a number of sequential wash water streams containing less and less sodium, while removing approximately the same amount of lithium chloride in each wash. In various embodiments, any number of washes may be used. In various embodiments, the produced solids 256 are lithium carbonate solids that are not completely dry. Thus, in various embodiments, the solids 256 may be sent to a dryer (not shown).

In various embodiments, the apparatus 200 includes any number of recycled streams with corresponding controllable valves. For example, a first controllable valve 258 of FIG. 2A may be adjusted in associated with a lithium carbonation waste 248 stream of FIG. 2B that is recycled as indicated by arrow 260 which is connected by circles 4. In various embodiments, the recycled stream 260 may be controllable via a valve and split stream.

In some embodiments, some or all of the RO permeate 234 of medium pressure RO unit 232 may be recycled and mixed with fresh water makeup 212 as indicated by arrow 262, which is connected between FIG. 2A and FIG. 2B via circles 2. In various embodiments, the recycle stream 262 may be controlled via a valve, split stream, and/or variable control device.

In some embodiments, another recycle stream may be formed from the combination of NF reject stream 224, lithium carbonation waste 248, and wash waste water 254, as indicated by arrow 264, which is connected by circles 3 and combined to re-fed into the apparatus 100 just before a controllable valve 265. In various embodiments, the MPC 198 can control the recycle stream 264 using the controllable valve 265 based on pH, electrical conductivity, lithium content, a lithium/impurity ratio, flow rate, temperature, pressure, or any combination thereof.

It is to be understood that the block diagrams of FIGS. 2A and 2B are not intended to indicate that the apparatus 200 is to include all of the components shown in FIGS. 2A and 2B. Rather, the apparatus 200 can include fewer or additional components not illustrated in FIGS. 2A and 2B (e.g., additional streams, filters, feedback loops, etc.). For example, in some embodiments, the MPC can control one or more recycle streams based a detected change in conductivity from an electrical conductivity meter (not shown). For example, the apparatus 200 may include an electrical conductivity meter located after the DLE unit 214. For example, the electrical conductivity meter can used to measure the conductivity of the stream passing between the DLE unit 214 and the subsequent CRC system. For example, the conductivity of the output stream may be used to estimate a total number of ions present in the stream at any point in time. Thus, if, for example, the calcium in the received output stream from the DLE unit 214 triples and the magnesium doubles, and the chloride also doubles, then the electrical conductivity of the stream will rise. In some embodiments, the MPC 198 can use the controller to adjust the controllable valve 258. For example, the controller may be coupled to a flow rate adjuster and a pH adjuster to control a flux rate adjustment, pH adjustment, or both, in response to detecting a change in conductivity in the pretreated stream. In various examples, the flow rate adjuster may include a controllable valve 258 that is adjusted to open or close based on the readings of the conductivity meter. In this manner, the permeate flow rate may be adjusted to indirectly control the flux rate. In various examples, the pH adjuster may include a valve that can be adjusted on an acid or caustic tank inlet.

In some embodiments, in response to detecting that the electrical conductivity has increased, it may be assumed that the DLE unit 214 is not rejecting as many impurities. Thus, for example, in response to detecting double the impurities coming into the nanofilter 222, the MPC 198 of apparatus 200 can increase the flux rate and immediately acidify to remove impurities quicker. Unlike a simple feedback circuit, the MPC 198 may also be able to know the time it takes for the change to actually impact an output. The apparatus 200 is thus able to make an online immediate or delayed change to the nanofiltration operation as appropriate, and thus prevent scaling of the nanofilter 222. Moreover, the apparatus 200 may reduce or prevent the loss of lithium to the ion exchange units 226, 228 and also reduce or prevent iron passage that may damage or destroy one or more downstream aspects of the apparatus 200.

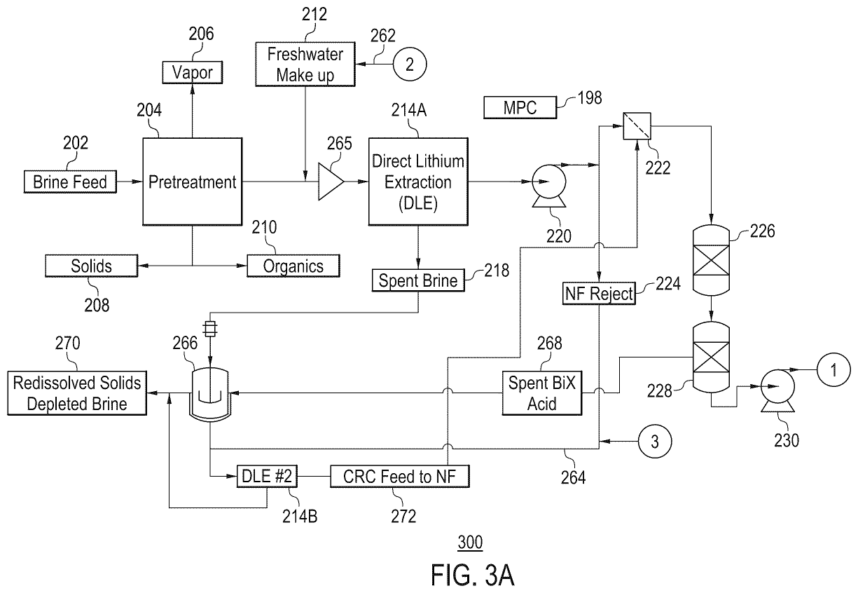

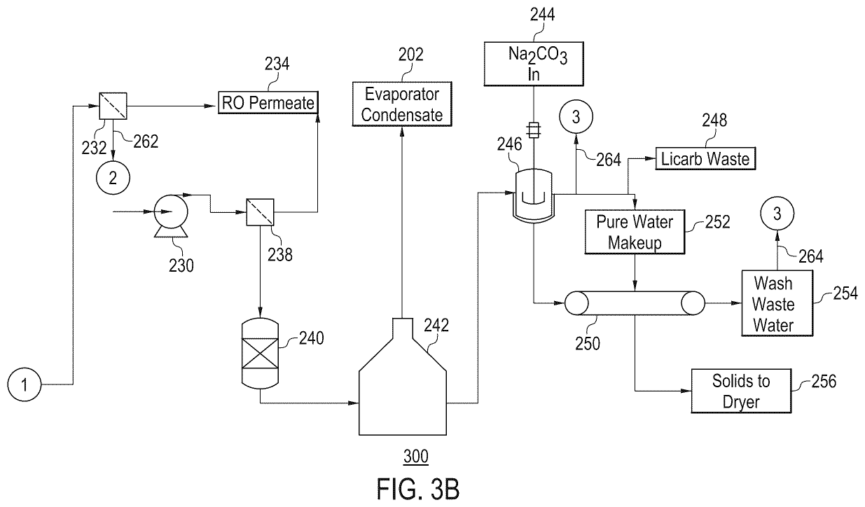

FIGS. 3A and 3B is a schematic diagram depicting an example control schema 300 for a lithium extraction system with two DLE units. In various embodiments, the nanofiltration control schema 300 can be implemented via a controller, such as the MPC 198. The control schema 300 of FIGS. 3A and 3B includes similarly referenced elements of FIGS. 2A and 2B.

Referring to FIG. 3A, the control schema 300 further includes a softening unit 266 fluidically coupled to the DLE unit 214, the boron ion exchange 228, and a second DLE unit 214B.

In various embodiments, the softening unit 266 receives spent brine 218 from a first DLE unit 214A and spent boron ion exchange acid 268 from the boron ion exchange 228 and produces a softened stream that is sent to the second DLE unit 214B and a redissolved solids depleted brine stream 270. For example, the redissolved solids depleted brine stream 270 may include sodium carbonate, lithium carbonate, potassium carbonate, calcium carbonate, and/or magnesium carbonate.

The second DLE unit 214B receives the softened stream from the softening unit 266 and outputs DLE eluate that is sent to be mixed with the redissolved solids depleted brine stream 270 and a concentration, refinement, and conversion (CRC) feed stream 272 that is sent to the nanofilter 222.

In various embodiments, the MPC 198 may receive sensor data, such as temperature, pressure, flow rate, density, total dissolved solids, turbidity, gas phase %, electrical conductivity, and/or pH, and adjust one or more controllable components, such as temperature (cooling water input or steam input), pressure (pump speed), flow rate (valve % open), and/or reagent injection.

It is to be understood that the block diagrams of FIGS. 3A and 3B are not intended to indicate that the control schema 300 is to include all of the components shown in FIGS. 3A-3B. Rather, the control schema 300 can include fewer or additional components not illustrated in FIGS. 3A-3B (e.g., additional streams, filters, feedback loops, etc.).

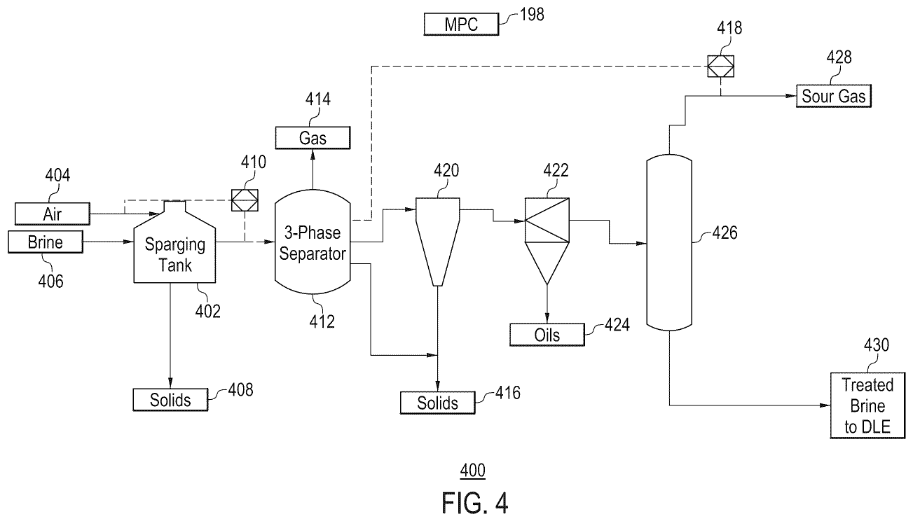

FIG. 4 is a schematic diagram depicting an example control loops in a pretreatment system 400 of a lithium plant, according to an embodiment. In various embodiments, the pretreatment system 400 can be used to implement any of the methods 600A-600C below.

The example pretreatment system 400 includes a sparging tank 402 shown receiving air 404 and brine 406. For example, the brine 406 may be lithium containing brine from a reservoir. The sparging tank produces solids 408 and a treated stream that is monitored using a meter 410 as it is sent to a three-phase separator 412, which is fluidically coupled to the sparging tank 402.

The three-phase separator 412 receives the treated stream from the sparging tank 402 and produces gas 414, solids 416, and a liquid stream. As discussed below, a second meter 418 enables a control loop to be associated with the three-phase separator 412.

The pretreatment system 400 also includes a desander 420 fluidically coupled to the three-phase separator 412. For example, the desander 420 can remove additional solids 416, such as smaller particles of sand that may have not been removed by the three-phase separator 412. The desander 420 outputs a desanded stream to a fluidically coupled de-oiling cyclone 422.

The de-oiling cyclone 422 removes oils 424 from the received desanded stream. For example, the de-oiling cyclone 422 can perform a cyclone removal for more trace oil from the desanded stream. In various embodiments, such removed trace oils include acetate, propionate, glycolate, and/or formate, among other potential trace oils.

In various embodiments, the meter 410 is employed on the outlet of the air sparging tank 402. For example, the meter 410 may be an electrical conductivity meter, pH probe, or density meter. In some embodiments, the meter 410 is used to determine effectiveness of iron and silica knockout. For example, if there is additional iron and silica in the treated stream that was not taken out via sparging, the pH would change, the electrical conductivity could increase, or the density of the stream could increase, which may require an increase in the flowrate of air 404. Alternatively, if there is too much air 404 and the air 404 solubilizes in the water of brine 406, the density would decrease, and the air flow rate would need to decrease.

As shown in FIG. 4, the overheads of the H₂S stripper 426 has a feedback line to the three-phase separator 412. The outputs of the H₂S stripper 426 are sour gas 428 and treated brine 430. In some embodiments, it may be assumed that the three-phase separator 412 removes most of the vapor in the brine received from the sparging tank 402, with the remaining ppm levels being removed via steam or natural gas stripping. In some embodiments, if the values in the overheads are too high as read via gas chromatography, then the three-phase separator 412 may be provided a higher vapor space to remove H₂S, or the stripper 426 may increase overall steam injection (not shown).

In various embodiments, the MPC 198 may take these control loops into consideration with other loops of other systems in order to optimize an overall objective function, to increase lithium production, increase divalent removal, or any combination thereof. In some embodiments, the MPC 198 may set one or more of the control loops to behave less than optimally when considered as an isolated loop. However, the combination of one or more sub-optimally configured feedback loops may in fact result in an optimized overall objective function, or may increase lithium production or divalent removal from the brine stream overall. Thus, the MPC 198 may enable a real-time adjustment to one or more controls in the lithium plant to improve the efficiency of lithium production or divalent removal, among other potential benefits.

It is to be understood that the block diagrams of FIG. 4 is not intended to indicate that the pretreatment system 400 is to include all of the components shown in FIG. 4. Rather, the pretreatment system 400 can include fewer or additional components not illustrated in FIG. 4 (e.g., additional streams, components, feedback loops, etc.).

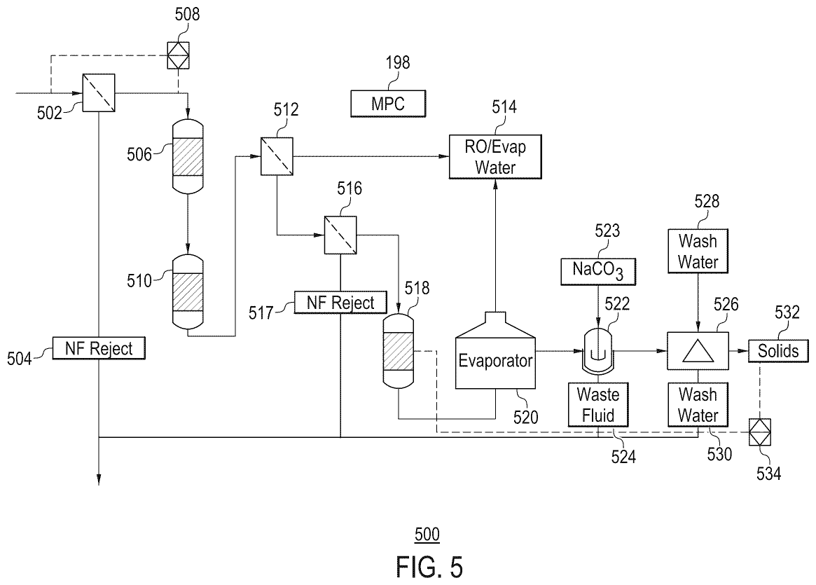

FIG. 5 is a schematic diagram depicting an example control loops in a concentration, refinement, and conversion (CRC) system 500 of a lithium plant, according to an embodiment. In various embodiments, the CRC system 500 can be used to implement any of the methods 600A-600C below.

The CRC system 500 includes a first nanofilter 502 that receives a pretreated brine stream and generates a nanofilter reject stream 504. For example, the nanofilter 502 may be a low pressure nanofilter that operates at pressures under 600 psi, or 4137 kPa. The nanofilter 502 produces a filtered stream that is sent to a divalent ion exchange (IX) unit 506. The CRC system 500 further includes a meter 508 to measure the electrical conductivity or density out of the permeate stream from the nanofilter 502.

The CRC system 500 includes a boron ion exchange (IX) unit 510 fluidically coupled to the divalent IX unit 506. The boron ion IX unit 510 the divalent IX unit 506 receives a filtered stream from the divalent IX unit 506 and filters out boron from the filtered stream and outputs a boron reduced stream. The boron reduced stream is sent to a reverse osmosis (RO) unit 512 that is also fluidically coupled to the boron IX 510.

The RO unit 512 may be a high pressure reverse osmosis filter that operates at a pressure of approximately 1,800 psi, or 12,411 kPa. The RO unit 512 includes a membrane used to filter solvents from various solutes. In various embodiments, the RO unit 512 retains solute on the pressurized side of the membrane and the purified solvent passes to the other side. In some embodiments, the reverse osmosis permeate or purified solvent is purified water 514. For example, the RO unit 512 can filter lithium solutes as well as other solutes, such as sodium.

The CRC system 500 includes a high pressure nanofilter 516 that is fluidically coupled to the RO unit 512. In various embodiments, the high pressure nanofilter 516 operates at a pressure of approximately 1,200 psi, or 8,274 kPa. The high pressure nanofilter 516 produces nanofilter reject stream 517 and a filtered stream that is sent to a second boron IX unit 518, that is fluidically coupled to the high pressure nanofilter 516.

The second boron IX unit 518 filters out additional boron from the filtered stream and outputs a boron reduced stream. The boron reduced stream is sent to an evaporator 520 that is fluidically coupled to the boron IX unit 518. The evaporator 520 generates purified water 514 and concentrate that is sent to lithium carbonation unit 522, which is fluidically coupled to the evaporator 520. The lithium carbonation unit 522 receives sodium carbonate 523 and produces waste fluid 524 and a carbonate slurry.

The CRC system 500 also includes washing unit 526 fluidically coupled to the lithium carbonation unit 522. The washing unit 526 receives wash water 528 and carbonate slurry and produces wash water waste 530 and solids 532. In some embodiments, the wash water waste 530 is discarded along with the NF reject 504 and waste fluid 524.

In various embodiments, a flux rate of the nanofilter 502 can be changed based on the the electrical conductivity or density out of the permeate stream detected by the meter 508. For example, in response to detecting too much salt passage, the flux may be decreased to allow for better separation, which may ultimately decrease flow rate. In some embodiments, this step may be integrated with a stream out of an ion exchange to indicate if the stream has very low salt content to increase flux and allow a higher flow rate for more ion passage.

In some embodiments, the lithium carbonation circuit can measure the boron or calcium content of the solids via a meter 534 and change the flowrate of the final ion exchange beds downstream of reverse osmosis at the second boron IX unit 518. For example, the MPC 198 may increase flow at the second boron IX unit 518 in response to detecting that the impurities do not exceed a threshold. In some embodiments, the MPC 198 can decrease the flow in response to detecting that the impurities exceed a second higher threshold. In various embodiments, the amount in which the flow is adjusted may depend on various other factors, such as factors that may affect lithium production, divalent removal, etc.

It is to be understood that the block diagrams of FIG. 5 is not intended to indicate that the CRC system 500 is to include all of the components shown in FIG. 5. Rather, the CRC system 500 can include fewer or additional components not illustrated in FIG. 5 (e.g., additional streams, components, feedback loops, etc.).

Table 1 below shows the impact of increased reagents during a chemical precipitation step. Data was collected through tests performed in a lithium extraction facility. As can be seen in tests 2 and 3, an increase of sodium carbonate results in a loss of 1% of lithium but an increase of 18% divalent removal. Moreover, an increase of sodium hydroxide results in a 1% loss of lithium but only a 2% increase in divalent removal. In various embodiments, an MPC can maximize value for a facility based on reagent cost, further divalent removal (such as ion exchange), and lithium recovery.

TABLE 1
Impact of Increased Reagents during Chemical Precipitation

| | Test | | | | |
|---|---|---|---|---|---|
| | 1 | 2 | 3 | 4 | 5 |
| Stir Rate | 600 | 300 | 300 | 300 | 300 |
| Na₂CO₃ Addition | 1 | 0.8 | 1.2 | 1 | 1 |
| NaOH Addition | 1 | 1 | 1 | 0.8 | 1.2 |
| Li Recovery | 95.7 | 94.7 | 93.7 | 94.0 | 92.8 |
| B removal | 15.0 | 15.4 | 16.7 | 16.5 | 17.6 |
| Divalent Removal | 81.6 | 70.4 | 88.3 | 79.7 | 81.7 |
| Ba Removal | 77.1 | 62.2 | 89.7 | 72.1 | 76.8 |
| Ca Removal | 89.4 | 77.6 | 95.8 | 87.5 | 89.5 |
| Mg Removal | 14.3 | 11.4 | 19.5 | 13.8 | 15.1 |
| Sr Removal | 56.0 | 41.5 | 72.6 | 52.0 | 56.4 |

Table 2 below shows nanofiltration table that shows boron and calcium rejection against flux, pH and membrane recovery. Data was similarly collected through tests performed in a lithium extraction facility. As can be seen in tests 7-12, using higher ranges of pH has an effect on the efficiency of removal of various ions.

TABLE 2
Boron and Calcium Rejection Against Flux, pH and Membrane Recovery

| | Test | Test | Test | Test | Test | Test | Test | Test | Test | Test | Test | Test |
|---|---|---|---|---|---|---|---|---|---|---|---|---|
| | 1 | 2 | 3 | 4 | 5 | 6 | 7 | 8 | 9 | 10 | 11 | 12 |
| pH | 5.5 | 5.5 | 5.5 | 3 | 3 | 3 | 9 | 9 | 9 | 10 | 10 | 10 |
| Flux (GFD) | 9.0 | 8.7 | 8.4 | 8.4 | 10.2 | 8.5 | 8.9 | 10.3 | 9.0 | 9.2 | 13.0 | 6.0 |
| Per Pass | 10.9 | 13 | 8.2 | 10.2 | 11.9 | 7.5 | 11 | 10.6 | 8.9 | 9.9 | 14.5 | 6.4 |
| Per Membrane | | | | | | | | | | | | |
| Recovery | | | | | | | | | | | | |
| (vol %) | | | | | | | | | | | | |
| Ionic Passage | | | | | | | | | | | | |
| B | 96% | 91% | 91% | 90% | 85% | 89% | 62% | 63% | 64% | 26% | 41% | 48% |
| Ba | 11% | 16% | 15% | 5% | 4% | 6% | 38% | 36% | 46% | 37% | 57% | 65% |
| Ca | 16% | 24% | 22% | 7% | 5% | 9% | 51% | 50% | 59% | 47% | 62% | 70% |
| K | 94% | 87% | 94% | 88% | 80% | 89% | 90% | 87% | 89% | 81% | 85% | 87% |
| Li | 98% | 92% | 93% | 91% | 85% | 92% | 90% | 94% | 92% | 85% | 86% | 89% |
| Mg | 4% | 7% | 6% | 2% | 1% | 3% | 21% | 20% | 26% | 22% | 40% | 48% |
| Na | 80% | 89% | 92% | 87% | 80% | 89% | 89% | 87% | 87% | 81% | 83% | 86% |
| Sr | 9% | 15% | 13% | 4% | 3% | 6% | 36% | 34% | 42% | 36% | 55% | 64% |
| Zn | 82% | 86% | 91% | 79% | 70% | 84% | 10% | 32% | 29% | | | |

As seen in Table 2, in tests 4-6, decreasing the pH of the NF greatly reduces Ca passage (and other divalents). As seen in tests 7-12, increasing the pH greatly reduces the boron passage.

FIG. 6A is a process flow diagram of a method 600A for filtering ions from a brine stream. In various examples, the method 600A may be implemented using the apparatus the apparatuses 100-500 described in FIGS. 1A-5.

At block 602, sensor data from one or more sensors of lithium process is received at a model predictive controller. For example, the sensor data may include any number of measured parameters associated with a brine stream, including a flow rate, a temperature, a density, a pH, an electrical conductivity, total dissolved solids, total suspended solids, lithium content, sodium content, cationic content, total organic content, or any combination thereof.

At block 604, one or more processes are adjusted in real time to locally less optimal state via model predictive controller using a number of control parameters to optimize an overall objective function. For example, the one or more processes may be adjusted in response to detecting a change in at least one of the number of measured parameters of the pretreated brine stream.

Those skilled in the art will appreciate that the exemplary method 600A of FIG. 6A is susceptible to modification without altering the technical effect provided by the present techniques. In practice, the exact manner in which the method is implemented will depend, at least in part, on the details of the specific implementation. For example, in some embodiments, some of the blocks shown in FIG. 6A may be altered or omitted from the method 600A and/or new blocks may be added to the method 600A. For example, blocks 602 and 604 may be iteratively repeated as more sensor data is received from one or more sensors of the lithium process.

FIG. 6B is a process flow diagram of a method 600B for filtering ions from a brine stream. In various examples, the method 600B may be implemented using the apparatuses described in FIGS. 1A-4B.

At block 602, sensor data from one or more sensors of lithium process is received at a model predictive controller. For example, the sensor data may include any number of measured parameters associated with a brine stream, including a flow rate, a temperature, a density, a pH, an electrical conductivity, total dissolved solids, total suspended solids, lithium content, sodium content, cationic content, total organic content, or any combination thereof.

At block 606, one or more processes are adjusted in real time, via a model predictive controller, to a locally less optimal state using a number of control parameters to increase an overall lithium production of the lithium process. For example, the one or more processes may be adjusted in response to detecting a change in at least one of the number of measured parameters of the pretreated brine stream.

Those skilled in the art will appreciate that the exemplary method 600B of FIG. 6B is susceptible to modification without altering the technical effect provided by the present techniques. In practice, the exact manner in which the method is implemented will depend, at least in part, on the details of the specific implementation. For example, in some embodiments, some of the blocks shown in FIG. 6B may be altered or omitted from the method 600B and/or new blocks may be added to the method 600B. For example, blocks 602 and 606 may be iteratively repeated as more sensor data is received from one or more sensors of the lithium process.

FIG. 6C is a process flow diagram of a method 600C for filtering ions from a brine stream. In various examples, the method 600C may be implemented using the apparatus the apparatuses described in FIGS. 1A-4B.

At block 602, sensor data from one or more sensors of lithium process is received at a model predictive controller. For example, the sensor data may include any number of measured parameters associated with a brine stream, including a flow rate, a temperature, a density, a pH, an electrical conductivity, total dissolved solids, total suspended solids, lithium content, sodium content, cationic content, total organic content, or any combination thereof.

At block 608, one or more processes are adjusted in real time to a locally less optimal state via model predictive controller using a number of control parameters to increase divalent removal in the lithium process. For example, the one or more processes may be adjusted in response to detecting a change in at least one of the number of measured parameters of the pretreated brine stream.

Those skilled in the art will appreciate that the exemplary method 600C of FIG. 6C is susceptible to modification without altering the technical effect provided by the present techniques. In practice, the exact manner in which the method is implemented will depend, at least in part, on the details of the specific implementation. For example, in some embodiments, some of the blocks shown in FIG. 6C may be altered or omitted from the method 600C and/or new blocks may be added to the method 600C. For example, blocks 602 and 608 may be iteratively repeated as more sensor data is received from one or more sensors of the lithium process.

In one or more embodiments, the present techniques may be susceptible to various modifications and alternative forms, such as the following embodiments as noted in paragraphs 1 to 23:

1. An apparatus for lithium processing, including a number of sensors to measure a number of parameters of a brine stream; and a model predictive controller to adjust a processing of the brine stream via a number of control parameters in response to detecting a change in at least one of the number of measured parameters of the brine stream.

2. The apparatus of claim 1, where the at least one of the number of measured parameters includes a flow rate of the brine stream.

3. The apparatus of any of paragraphs 1-2, where the at least one of the number of measured parameters includes a temperature of the brine stream.

4. The apparatus of any of paragraphs 1-3, where the at least one of the number of measured parameters includes a density of the brine stream.

5. The apparatus of any of paragraphs 1-4, where the at least one of the number of measured parameters includes a pH of the brine stream.

6. The apparatus of any of paragraphs 1-5, where the at least one of the number of measured parameters includes an electrical conductivity of the brine stream.

7. The apparatus of any of paragraphs 1-6, where the at least one of the number of measured parameters includes total dissolved solids in the brine stream.

8. The apparatus of any of paragraphs 1-7, where the at least one of the number of measured parameters includes total suspended solids in the brine stream.

9. The apparatus of any of paragraphs 1-8, where the at least one of the number of measured parameters includes lithium content of the brine stream.

10. The apparatus of any of paragraphs 1-9, where the at least one of the number of measured parameters includes sodium content of the brine stream.

11. The apparatus of any of paragraphs 1-10, where the at least one of the number of measured parameters includes cationic content of the brine stream.

12. The apparatus of any of paragraphs 1-11, where the at least one of the number of measured parameters includes total organic content of the brine stream.

13. The apparatus of any of paragraphs 1-12, where the model predictive controller includes a dynamic matrix controller.

14. The apparatus of any of paragraphs 1-13, where the number of control parameters include liquid, gas, organic levels or flows in a three phase separator.

15. The apparatus of any of paragraphs 1-14, where the number of control parameters include steam rate or temperature in a hydrogen sulfide stripper.

16. The apparatus of any of paragraphs 1-15, where the number of control parameters include flux through a filter.

17. A method of operating a lithium plant, the method including receiving, at a model predictive controller, sensor data from a sensor of a lithium process; and adjusting, via the model predictive controller, a process in real time to a locally less optimal state using a number of control parameters to optimize an objective function.

18. The method of claim 17, where the objective function is associated with an overall operation of the lithium plant.

19. The method of any of paragraphs 17-18, including adjusting the process to increase an overall lithium production of the lithium process.

20. The method of any of paragraphs 17-19, including adjusting the process to increase a divalent removal of the lithium process.

21. The method of any of paragraphs 17-20, where the process includes fine-tuning an addition of a reagent.

22. The method of any of paragraphs 17-21, where the process includes a reverse osmosis process.

23. The method of any of paragraphs 17-22, where the process is adjusted to run in the locally less optimal state in order to optimize a second process of the lithium process.

While the present techniques may be susceptible to various modifications and alternative forms, the embodiments discussed above have been shown only by way of example. However, it should again be understood that the techniques is not intended to be limited to the particular embodiments disclosed herein. Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated. All numerical values within the detailed description herein are modified by “about” the indicated value, and take into account experimental error and variations that would be expected by a person having ordinary skill in the art. Indeed, the present techniques include all alternatives, modifications, and equivalents falling within the true spirit and scope of the appended claims.

What is claimed is:

1. An apparatus for lithium processing, comprising:
a plurality of sensors to measure a plurality of parameters of a brine stream; and
a model predictive controller to adjust a processing of the brine stream via a plurality of control parameters in response to detecting a change in at least one of the plurality of measured parameters of the brine stream.

2. The apparatus of claim 1, wherein the at least one of the plurality of measured parameters comprises a flow rate of the brine stream.

3. The apparatus of claim 1, wherein the at least one of the plurality of measured parameters comprises a temperature of the brine stream.

4. The apparatus of claim 1, wherein the at least one of the plurality of measured parameters comprises a density of the brine stream.

5. The apparatus of claim 1, wherein the at least one of the plurality of measured parameters comprises a pH of the brine stream.

6. The apparatus of claim 1, wherein the at least one of the plurality of measured parameters comprises an electrical conductivity of the brine stream.

7. The apparatus of claim 1, wherein the at least one of the plurality of measured parameters comprises total dissolved solids in the brine stream.

8. The apparatus of claim 1, wherein the at least one of the plurality of measured parameters comprises total suspended solids in the brine stream.

9. The apparatus of claim 1, wherein the at least one of the plurality of measured parameters comprises lithium content of the brine stream.

10. The apparatus of claim 1, wherein the at least one of the plurality of measured parameters comprises sodium content of the brine stream.

11. The apparatus of claim 1, wherein the at least one of the plurality of measured parameters comprises cationic content of the brine stream.

12. The apparatus of claim 1, wherein the at least one of the plurality of measured parameters comprises total organic content of the brine stream.

13. The apparatus of claim 1, wherein the model predictive controller comprises a dynamic matrix controller.

14. The apparatus of claim 1, wherein the plurality of control parameters comprise liquid, gas, organic levels or flows in a three phase separator.

15. The apparatus of claim 1, wherein the plurality of control parameters comprise steam rate or temperature in a hydrogen sulfide stripper.

16. The apparatus of claim 1, wherein the plurality of control parameters comprise flux through a filter.

17. A method of operating a lithium plant, the method comprising:
receiving, at a model predictive controller, sensor data from a sensor of a lithium process; and
adjusting, via the model predictive controller, a process in real time to a locally less optimal state using a plurality of control parameters to optimize an objective function.

18. The method of claim 17, wherein the objective function is associated with an overall operation of the lithium plant.

19. The method of claim 17, comprising adjusting the process to increase an overall lithium production of the lithium process.

20. The method of claim 17, comprising adjusting the process to increase a divalent removal of the lithium process.

21. The method of claim 17, wherein the process comprises fine-tuning an addition of a reagent.

22. The method of claim 17, wherein the process comprises a reverse osmosis process.

23. The method of claim 17, wherein the process is adjusted to run in the locally less optimal state in order to optimize a second process of the lithium process.
